(19) United States
(12) Patent Application Publication
(10) Pub. No.: US 2013/0194928 A1
(43) Pub. Date: Aug. 1, 2013

(54) SENSOR NETWORK

(71) Applicant: NANYANG TECHNOLOGICAL UNIVERSITY, Singapore (SG)

(72) Inventor: Muhammad Mudasser IQBAL, Singapore (SG)

(73) Assignee: NANYANG TECHNOLOGICAL UNIVERSITY, Singapore (SG)

(21) Appl. No.: 13/754,357

(22) Filed: Jan. 30, 2013

Related U.S. Application Data
(60) Provisional application No. 61/592,032, filed on Jan. 30, 2012.

(51) Int. Cl. H04L 12/56

(52) U.S. Cl. CPC H04L 47/70
USPC 370/235

(57) ABSTRACT

Method of using a sensor network for improving data flow of the sensor network comprises a step of identifying components of the sensor network, a step of estimating resource footprints of the components; and a step of modifying policies of the sensor network for governing data flow.

The present application relates to a sensor network. It also relates to methods of using, installing, configuring, assembling, modifying and upgrading the sensor network.

Sensor networks are often used to monitor and respond to parameters of environment in real time. For example, a sensor network is deployed to check air and water borne pollutants in large cities and suburban areas. Many sensor networks have been installed to monitor volcano activities, soil conditions in an agricultural field, and temperatures distribution of a building.

Known sensor networks has been focused on minimizing physical sizes and energy consumption of sensor or sensor nodes, and on reducing cost of installing large scales of sensor networks. However, large scales of sensor networks have not been proven to be both technically feasible and commercially viable.

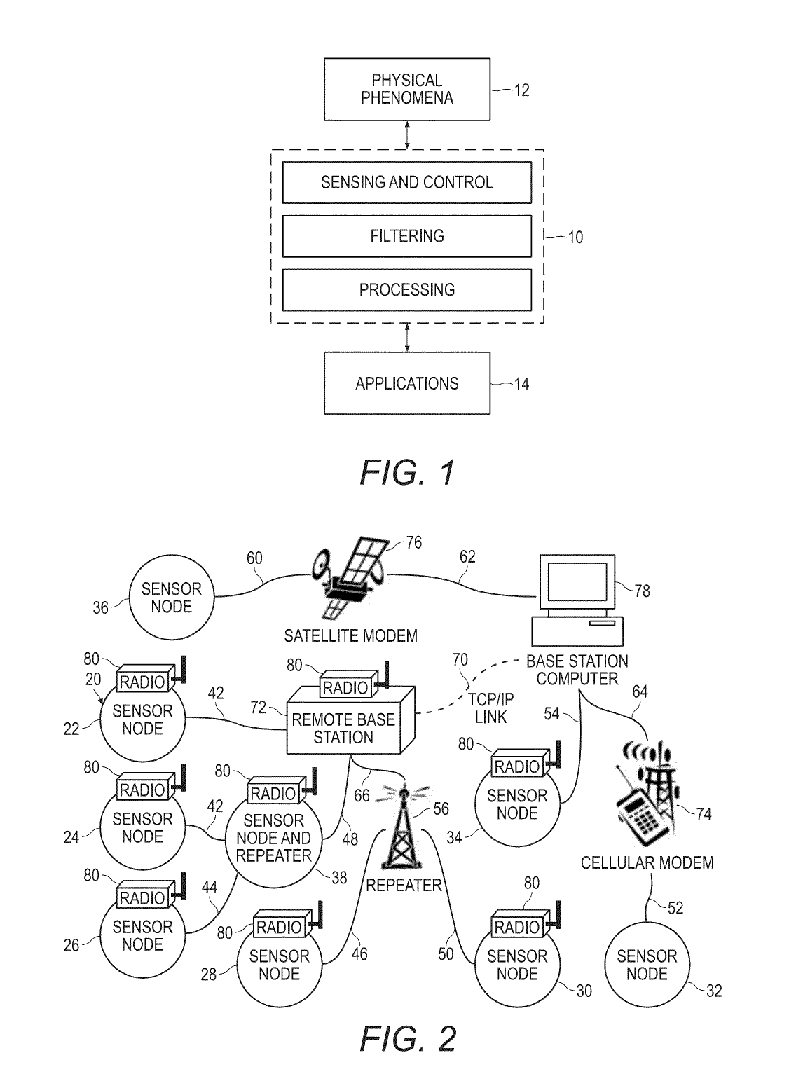

FIG. 1 shows a known sensor network 10 that comprises sensor nodes and actuators. The sensor nodes form the sensor network 10 for monitoring seismic electric signals of the ground, which are indicators of physical phenomena 12 (e.g. earthquake). The known sensor network 10 is installed with software applications 14 for sensing, controlling, filtering and processing the received seismic electric signals. The seismic electric signals are detected at stations, which include ground-inserted electrodes (oriented NS and EW), amplifiers and filters. The seismic electric signals are recorded and collected as data, which is subsequently processed either at a sensor node locally, at an intermediate location within the network, or at the back-end infrastructure/computer station. The processing performed by the sensor network 10 relates to high-level goals of motivating applications, which is to predict earthquakes. Alongside with the data for the domain-specific application (e.g. predicting earthquake), sensor nodes also produce diagnostic data that helps quantify the evolving state of the sensor network 10.

While known sensor networks are useful to the scientists in data collection, the known sensor networks typically consume local resources such as the battery, communication bandwidth, storage etc. in a way that is optimal for the operation of the sensors themselves. For this very reason, the life and quality of sensor network seems to theoretically improve when provided with the maximum resources, such as batteries of large capacities, wide network bandwidth (larger than the data transferring rate), large local storage on the sensor nodes (e.g. 10 GB) and high performance processors (e.g. 1 GHz). Nevertheless, according to experience, the “overkill” provision of physical resources at high cost does not guarantee reliable operation of the known sensor network.

A more viable arrangement of a sensor network is thus desired.

The present invention aims to provide a new and useful sensor network. It also aims to improve performance of the sensor network by dealing with the above-mentioned problems. Essential features of the invention are provided by independent claims, whilst advantageous features are given by dependent claims. The present application claims the priority of U.S. provisional application 61/595,032, which was filed on 30 Jan. 2012. The entire content of the earlier application is hereby incorporated by reference.

According to a first aspect of the invention, the application provides a method of using a sensor network for improving data flow of the sensor network. The method comprises a first step of identifying components of the sensor network, a second step of estimating resource footprints of the components; and a third step of modifying policies of the sensor network for governing data flow. Alternatively, instead of estimating resource footprints of the components, the method comprises a step of examining resources status so that overriding objectives of an application of the sensor network can be achieved. In other words, the method enables the choice of policies in view of the overriding application of the sensor network (e.g. monitoring earthquake).

The method is a technique for improving data flow of the sensor network, which may be termed Optimization of Data Flow (OData). The OData technique is based on the following principles with their associated advantages:
a) reconfigurable component-based design,
b) functional specialization for operation under constraints to avoid overheads,
c) portable and retrofitable components,
d) support for distributed, concurrent and synchronized execution of multiple components,
e) end-to-end Quality of Service (QoS) under both global and local constraints,
f) periodic and aperiodic events processing,
g) real-time adaptive scheduling and
h) composable complex workflows.

OData technique/method enables a sensor network to dynamically adjust its data flow pattern in response to application demands and limitations of the sensor network. OData technique avoids excessive provision of hardware and software resources to the sensor network. The OData network is also responsive to both external environment (physical phenomena) and internal environment (sensing components, constraints, restrictions and policies). In other words, the sensor network becomes intelligent in selecting an optimum pattern of data flow so that performance, reliability, life span and energy consumption of the sensor network are improved.

The method can further comprise a step of checking constraints of the sensor network. The constraints are limits of resources available to sensor nodes of the sensor network. The constraints are dynamic, and they dictate usable/available power/electricity, processing capacity, sensing resolution and other technical boundaries of the resources. Since OData technique can cause the sensor network to check the constraints, a suitable policy of data flow may be selected for regulate the sensor network.

The method may further comprise a step of determining restrictions of the sensor network. The restrictions are boundaries of configurability on the components and assumptions made to the resources. For example, the restrictions include a lower limit of bandwidth which allows a sensor node to transmit data. Since the sensor network is configured to notice the restrictions, the sensor network is able to operate reliably within the restrictions, keeping its performance to an optimum level.

The method can further comprise a step of examining resource status of the sensor network. Since resources of the sensor network are not constant, the OData technique causes the sensor network to adapt its policies in view of different resource status over time.

The step of modifying policies of the sensor network can comprise a further step of choosing some of the components dynamically for improving resource consumption or data delivery. Although all available components may be useful for a sensor node of the sensor network, not all the available components are necessary for every pattern of data flow, or policies. Accordingly, the OData technique enables the sensor node to select only necessary components for an assigned task at a time. By dropping unnecessary components, the sensor node, and eventually the sensor network, carries out the task of data collection, processing and transmission with less “burden”. As a result, power consumption of the sensor network may be reduced.

The method may further comprise a step of tracking anomaly of the sensor network for updating resource utility of the sensor network. The anomaly or irregularity of the sensor network often adversely affects the sensor work so that the sensor network can adjust of select suitable policies for reroute the data flow. Instead malfunction, the sensor network is made to transform itself for data transmission by following different policies.

The method can again comprise a step of calculating the cost of the data flow for improving data output of the sensor network. The cost includes consumption of processing power (e.g. number of CPU cycles), depletion of electricity (power used up by transferring the number of bytes) and usage of battery (power spent for storing the number of bytes on a flash memory). Hence, the OData technique allows the sensor network to choose a policy for minimizing the cost for operation. If the sensor network is distributed over a large area of forest, minimizing the cost on battery usage is beneficial for reducing the requirements on battery replacement, which time and labor demanding in this situation.

The step of checking constraints of the sensor network may comprise a step of computing resource utility (Uᵣ) of one or more of the component according to the equation of

$${U}_{rt} = \frac{{S}_{t}}{{E}_{t}} .$$

Sₜ is a number of data points served by a particular resource and Eₜ is a number of data points expected at time t. The equation helps the sensor network to quantify actual value of each resource in different situations and at different times, which is dynamically accurate and in time. Thus, resources of the sensor network can be better managed and deployed.

The method further can also comprise a step of formulating one or more of the policies according to the equation of pᵢ={d, t, r}. “Pᵢ” denotes one of the policies. “d” is a set of sensor data with both spatial context and temporal resolution, and t is a time constraint on a sampling data of the sensor network. “r” (symbolizes a ranked priority of the policy. Since selection of a policy is affected by the data, the time and the priority, the sensor network can choose a suitable policy in view many factors for achieving desired performance.

The method may further comprise a step of measuring data utility U_{d} of the one or more policies according to the equation of

$${U}_{dt} = \frac{{D}_{t}}{{E}_{t}} .$$

“Dₜ” is the number or data points delivered, whilst “Eₜ” is the number of data points expected at time t. Since the sensor network check data usage by the application of the sensor network, the OData technique becomes “result-orientated”, and can avoid excessive data collection or transmission, which may over burden the sensor network.

The step of estimating resource footprints (F_{cx}) of the sensor network can be performed according to the equation of F(cₓ)=[f(r_{y}, g_{z})|r_{y} ⊂ R and g_{z} ⊂ G_{c}_{ₓ}]. “Cₓ” denotes one of the components, “cₓ ⊂ C” is a component of interest, “G_{c}_{ₓ}” is a set of all possible configurations the component cₓ, available. “R” is the resources on the sensor network. “f(r_{y}, g_{z})” is the impact of component cₓ on a resource in the resource set R when the component's configurations are varied within the set G_{c}_{ₓ}. Moreover, the step of estimating resource footprints (F_{c1x, r1y}) of one of the components may be performed according to the equation of F(cₓ, r_{y})=[f(r_{y}, g_{z})|g_{z} ⊂ G_{c}_{ₓ}]. “Cₓ” denotes one of the components. “cₓ ⊂ C” means a component of interest. “G_{c}_{ₓ}” stands for a set of all possible configurations the component cₓ, available “R” signifies the resources on the sensor network. “f(r_{y}, g_{z})” represents the impact of component c, on a resource in the resource set R when the component's configurations are varied within the set G_{c}_{ₓ}. Having the resource footprint (usage pattern or consumption) is useful for an algorithm of the sensor network (OData technique) to pick and deploy certain components such that the sensor network can use it resource wisely for achieving its objectives. For example, the sensor network can choose to store data locally at buffers of some sensor nodes, instead of transmitting the data wirelessly because the wireless transmission requires more electric power than the alternative.

The tracking anomaly of the sensor network can be performed according to the equation of COPₜ=[Uᵣₜ, U_{dt}, R]. “R” is the resource available at time t. “Uᵣₜ” means the resource utility at time t and “U_{dt}” represents the data utility at time t. Since anomaly or irregularity often reduces the capacity of the sensor network, OData technique can alter policies for reducing the negative impact of various anomalies.

The step of modifying policies of the sensor network may comprise following steps:
a. a step of selecting one of the policies at rank x−1;
b. a step of forming a new graph with the components needed to satisfy the new policy;
c. a step of calculating the cost of vertices of the new data flow graph;
d. a step of deciding data and resource utility by analyzing the cost associated with the edges of the new data flow graph;
e. If both the data and resource utilities are improved and the resource consumption projections meet the policy specifications, a step of executing the new data flow graph, if not, a step of adopting a lower ranked policy and following the above-mentioned steps a-again till both the data and resource utilities are improved and the resource consumption projections meet the policy specifications.

The above-mentioned steps a-e enable the sensor network to identify a suitable policy incrementally, which can be easily executed by a computer program for arriving the suitable policy quickly.

According to a second aspect of the invention, the application provides a sensor network that comprises one or more sensor nodes for monitoring physical phenomena, and a base station computer connected to the one or more sensor nodes for executing its installed applications based on data collected by the sensor nodes. The sensor network is configured to identify components of the sensor network, estimate resource footprints of the components; and modify policies of the sensor network for governing data flow. Accordingly, the sensor network becomes active, instead of passive. The sensor network can constantly adjust its data flow patterns following a suitable policy so that overall performance of the sensor network is continuously monitored, maintained and adjusted. The sensor network thus becomes dynamically responsive to both its internal and external conditions.

According to a third aspect of the invention, the application provides a method of installing, configuring, assembling, modifying, connecting or upgrading a sensor network. The method comprises a step of loading one or more computer program to a base station computer, a remote base station computer, a sensor node or a combination of any of these for executing following steps a-c, which include
a. A step of identifying components of the sensor network;
b. A step of estimating resource footprints of the components; and
c. A step of modifying policies of the sensor network for governing data flow.

The fundamental advantage of the method is that it can help ensure application-level quality of service for data delivery while at the same time making sure that the resources available at the sensing devices are consumed only to deliver that data quality of service.

The accompanying Figures (Figs.) illustrate embodiments and serve to explain principles of the disclosed embodiments. It is to be understood, however, that these Figs. are presented for purposes of illustration only, and not for defining limits of relevant inventions.

FIG. 1 illustrates interactions between a physical environment and a known sensor network;

FIG. 2 illustrates a sensor network for monitoring water pressure of distributed urban water pipelines;

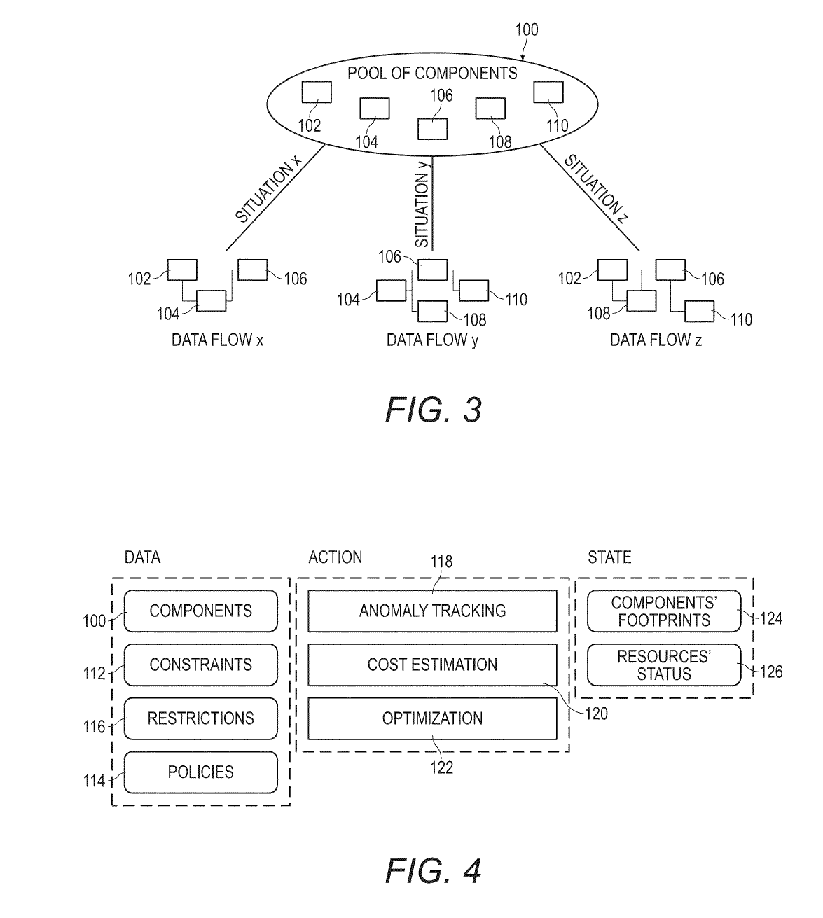

FIG. 3 illustrates the sensor network that chooses components dynamically for optimizing the consumption of resource, delivery of data;

FIG. 4 illustrates the sensor network where its devices operate with the combination of data, state and action tiers;

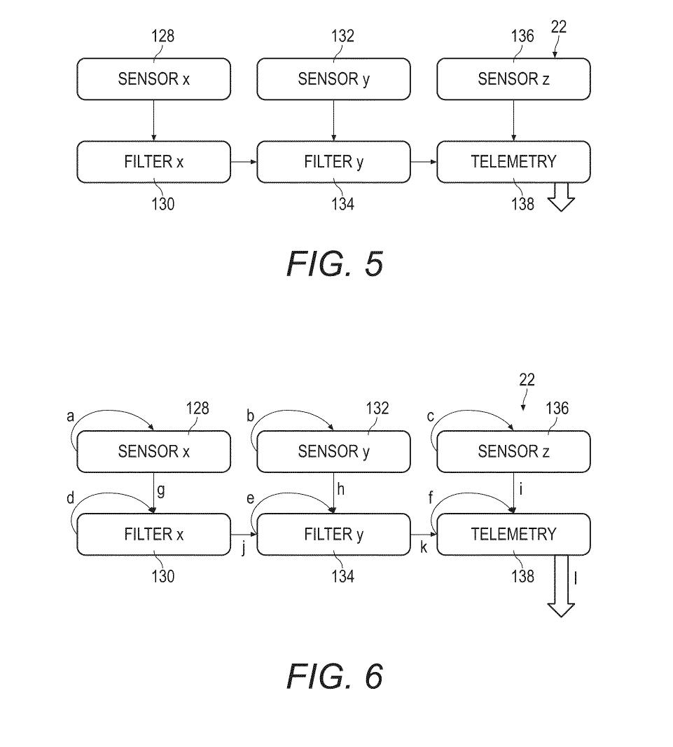

FIG. 5 illustrates data flow in a device of the sensor network;

FIG. 6 illustrates the sensor network having its data flow modeled as a graph with associated costs;

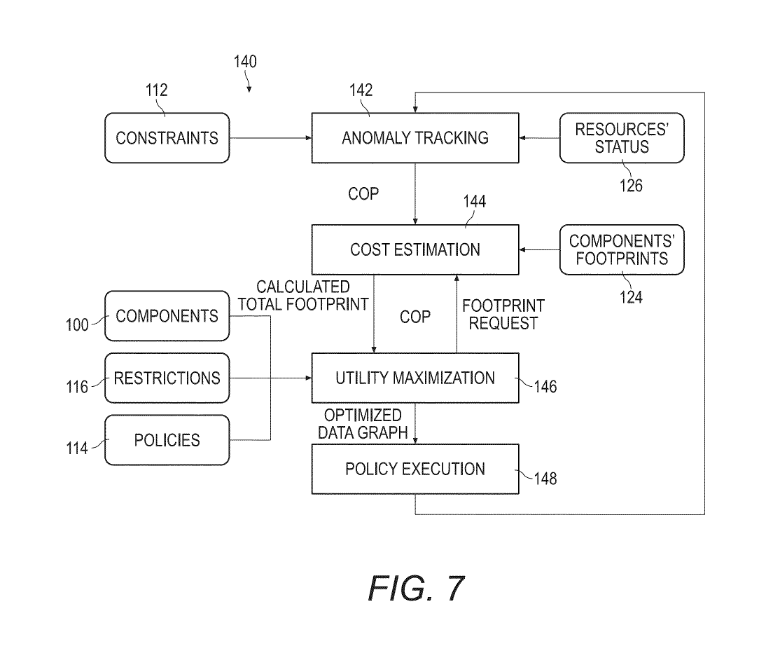

FIG. 7 illustrates a Data Flow Optimization Process of the sensor network;

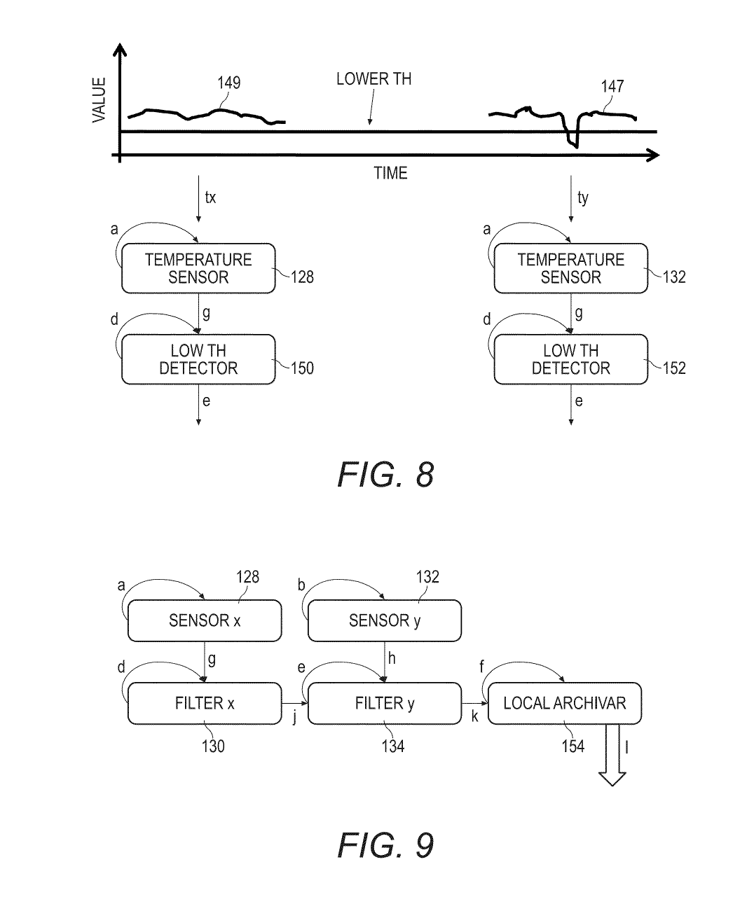

FIG. 8 illustrates undetermined resource footprints of some components; and

FIG. 9 illustrates a data flow graph generated according to the Data Flow Optimization Process.

Exemplary, non-limiting embodiments of the present application will now be described with references to the above-mentioned Figs.

FIGS. 2 to 9 relate to an embodiment of the present invention. In particular, FIG. 2 illustrates a sensor network 20 for monitoring pressure, temperature and flow rate values at various places of water pipelines (not shown) within a city. Fluctuation of the pressure temperature and flow rate values may indicate water leakages, water consumption rates or blockages.

The sensor network 20 comprises sensor nodes 22-36, cable connections 40-54, a repeater 56, wireless connections 60-66, a TCP/IP (Transmission Control Protocol/Internet Protocol) link 70, a remote base station 72, a cellular modem 74, a satellite modem 76 and a base station computer 78. The base station computer 78 is installed with an application software package for monitoring the pressure, temperature and flow rate values.

The sensor nodes 22-36 are attached to the water pipelines (not shown) at different parts of the city. Some of the sensor nodes 22-34 have been installed with radio transmitters 80 respectively such that they 22-34 can communicate with the remote base station 72 wirelessly or via their cable connections 40-54 for telemetry. The repeater 56 is provided for duplicating radio signals from the radio transmitters 80 of the sensor nodes 28, 30 such that alternative wireless connection 66 between the sensor nodes 28, 30 and the remote base station 72 are established. The TCP/IP link 70 facilitates communication between the remote base station 72 and the base station computer 78. Some of the sensor nodes 32-36 communicate directly with the base station computer 78. According to FIG. 2, the sensor node 32 communicates with the base station computer 78 via the cellular modem 74. The other sensor node 36 communicates with the base station computer 78 via connections 60, 62 to the satellite modem 76.

Some of the sensor nodes 22-36 are installed with one or more local non-volatile storage device (e.g. solid state memory, hard disk drive, flash memory), volatile memory (e.g. Random Access Memory), a processor (central processing unit) and a display unit that are connected to a PCB (Printed Circuit Board). Some of the sensor nodes 32 36 have modems (modulator-demodulator) 76, 74 for providing alternative communication channels. The sensor nodes 22-36 are also installed with locally embedded software for data collection and transmission, such as sensor drivers.

Referring to an OData technique (Data Flow Optimization Process), the sensor network 20 have sensing applications that start with a very limited idea of what type of data should be retrieved, how much data should this be retrieved, and what primary operations must be performed on it. The retrieve-all-you-can path is taken at the beginning. Various tests and experiments are carried out on the retrieved data to make sense of it so that correct models and data filtering techniques can be investigated, analyzed and agreed upon for adoption. In the same context, an example of such tests and experiments includes evaluation of event detection scenarios (e.g. for leaks, pipe bursts and water contamination/security events), each of the situations dictates its context and constraints. Such temporary tasks that the sensor network 20 supports are provided on-demand, defining the set of secondary operations.

Although not critical from a resource management perspective, secondary operations are also dealt similar to the primary operations in early stages. The secondary operations are important to determine the primary operations that the sensor network 20 supports for the rest of its life. The sensor network 20 also evolves over time, and the evolution will add to uncertainty and complexity of the sensor network 20. The sensor network 20 is monitored which mandates the ability to construct complex workflows and their prioritized scheduling for in-network or centralized execution.

FIG. 3 illustrates the sensor network 20 that chooses components 102-110 dynamically for optimizing the consumption of resource and delivery of data (OData technique). The sensor network 20 adopts the OData technique, which is a component-based framework based on Feature Oriented Software Design (FOSD). This OData technique categorizes the components 102-110 as either primary or secondary which prevents relevant sensor nodes 22-36 from over consuming resources (e.g. bandwidth, electricity) due to having unnecessary components 102-110 in the execution flow. For different resource conditions and application requirements, only the key elements/components 100 and their variants for carrying out a particular task are composed together. Only necessary components 102-110 are composed together so that useless data is not produced, and sensor network resources are not over consumed. OData technique does not make assumptions about routing schemes employed, duty cycles adopted to save power, packet formats for data exchange and provision of separate data and control channels. In contrast, OData technique 140 requires that directly or indirectly, the sensor nodes 22-36 are capable of monitoring their own resource levels and their rates of resource consumption. Software modules running on the sensor nodes 22-36 are dynamically reconfigured, started and stopped on-demand.

FIG. 4 illustrates the sensor network 20 where the sensor nodes 22-36 operate with the combination of data, state and action tiers. Referring to data flow within the senor network 20, OData technique 140 models each device or sensor node 22-36 as a combination of entities that have a certain freedom of re-configurability, which are exposed to certain constraints 112 and operate under strict application level policies 114. According to FIG. 4, the sensor node's activity cycle has been modeled as a combination of data, state and action tiers. The data tier defines the capabilities of a device (sensor node 22-36) as well as the modes of its operation. An example within the data tier is a device's ability to read data from a specific sensor at one or more pre-defined sampling rates, and according to a daily schedule. One sensor node 22-36 comprises several sensors.

FIG. 4 shows that data are collected and processed by the sensor network 20 according to the grouping of components 100, constraints 112, restrictions 116 and policies 114. The sensor nodes 22-36 perform anomaly tracking 118, cost estimation 120 and optimization 122. As indication of their state, the sensor nodes 22-36 keep information on resource usage of the components 100 (e.g. power consumption), which is components' footprints 124. The sensor nodes 22-36 further monitor resource status 126 (e.g. battery level).

FIG. 5 illustrates data flow in a device (sensor node 22) of the sensor network 20. Under normal circumstances, only the data tier 100, 112, 114, 116 (see FIG. 4) that is of interest to the overriding applications are collected and processed. When the data tier 100, 112, 114, 116 cannot meet a given quality of service (QoS) objective (such as timeliness of data delivery), the action tier 118, 120, 122 constructs a different data flow to meet the QoS with the available resources. The action tier 118, 120, 122 does this by using the information provided by the state tier 124, 126 about the current state of system resources as well as footprint of each potential component in the data tier 100-116 that can be used in the new data flow. FIG. 5 shows a simplified view of a typical sense-filter-transmit data flow model within a device 22 comprising the following components: sensors 128, 132, 136, processing filters 130, 134 and telemetry 138.

FIG. 6 illustrates the sensor network 20 having its data flow modeled as a graph with associated costs. OData technique 140 models the data flow shown in FIG. 5 as a graph G(V, E) with the components 100 forming the set of vertices V and the data flow between them forming the set of edges E in the graph. Since it is the data that is flowing through the sensor network 20 and eventually sent out to the backend applications, each edge has been associated with cost estimation 120, which is the number of data points flowing on that edge. Likewise, each vertex (component 100) has its associated execution (CPU, memory) cost, as well as power consumption footprint. Thus, a new weighted graph emerges as shown in FIG. 6. The action tier 118, 120, 122 aims to select an appropriate graph such the application requirements are met. Entities (components 100, constraints 112, restrictions 116 and policies 114) of the data flow model will now be discussed in detail subsequently.

FIG. 7 illustrates a Data Flow Optimization Process 140 (OData technique) of the sensor network 20. Based on certain factors 100, 112, 114, 116, 124, 126, the OData technique 140 performs anomaly tracking 142, cost estimation 144, utility optimization 146 and policy execution 148.

Referring to the components 100, they 100 are the building blocks of the data flow model 140. The components 100 define the capabilities of a device 22-36 (sensor nodes) such as sensing parameter, on-device processing, actuators, telemetry 80, 138, local buffering etc. The components 102-110 include pressure sensor, valve actuator, low pass filter and 3G data transfer.

Referring to constraints 112, each device 22-36 has a set of resources, which include
1. Power: battery and its capacity, direct power line and the terms of its usage;
2. Processing capacity: available CPU, flash memory and their configurations;
3. Communication speed: means of telemetry and the bandwidth available;
4. Storage volume: local permanent storage available and its capacity;
5. Sensing: sensors connected to the device and their modes of operation;
6. Actuators: actuators connected to the device and their modes of operation; and
7. Software: libraries supported and the reconfigurations possible.

Constraints 112 determine various states that a resource and a component 102-110 can live in and thus define the search space for the data flow optimization solutions. A matrix, resource utility Uᵣ at time t has been defined as:

$${U}_{rt} = \frac{{S}_{t}}{{E}_{t}} \qquad ( 1 )$$

where Sₜ is the number of data points served by a particular resource and Eₜ is the number of data points expected at time t. This matrix measures the usage of a particular resource, e.g. network bandwidth, against the number of data points it was used to serve, and what percentage of those data points were actually useful to the overriding applications. Thus, Uᵣₜ=1 means all the bytes that a network bandwidth has been used to send were exactly, and only the data points needed by the applications.

The same matrix with value greater than 1 would mean that the resource is being used sub-optimally and a value less than 1 would mean that either not enough data is being sent or the data being sent is useless. OData technique 140 always aims to keep the resource utility as close to 1 as possible. The notion of resource utility is very important as it helps to determine the actual value of each resource in different situations. In a worst case scenario where no data can be sent to the applications due to the network being unavailable, all measurements (data) are locally buffered (temporally stored). Although the utility value of the communication resource will reduce to 0 in this case, the resource utility matrix will still help the optimization function to store only the most application critical data on the local buffer. That is, when the network connectivity is resumed later on, the locally buffered data is sent to the remote base station 72 or the base station computer 78 for running the applications, the data maintains its utility from the application's perspective and is utilized to its maximum according to the policies 114.

Referring to the restrictions 116, they 116 define the boundaries of re-configurability on components 100 and assumptions that can be made about resources. Some examples of restrictions are:
1. The lower limit on the battery level that still allows the device to power its sensors for data acquisition;
2. The filters 130, 134 that can be applied to a particular component; although a sensor device 22-36 may have a low pass filter, it may not be equally applicable to all sensor types;
3. The set of sampling rates available for each type of sensors;
4. The range of actuation options available for various actuators in various conditions; and
5. Some sensors 128, 132, 136 may only provide specific sampling rates (i.e. 8 kHz, 12 kHz), so a data flow model assuming a continuous sampling band is invalid.

Referring to the policies 114, OData technique 140 employs the notion of data collection policies 114 to capture application-level QoS requirements. A policy 114 pi is described as:

pᵢ={d, t, r} (2)

where “d” is the set of sensor data needed with both spatial context and temporal resolution (e.g. half hourly average pressure data from all the sensors in the north zone of the city), t defines the time constraint on each sensor data (e.g. last/preceding half hour averages must reach the application level within five minutes of the instance of sampling/measurements) and r is the ranked priority of this policy 114. Policy ranking guides the optimization solution about the relative importance of different policies 114.

One example is a baseline policy 114 that follows the retrieve-all-you-can approach. Since it may not always be possible to achieve such aggressive data collection, alternative policies 114 is defined (and ranked) in accordance with the criticality of the data to specific applications. The ranking and policies 114 are derived from the application domain requirements. In addition, a QoS measure, the data utility “U_{dt}” at time t, is derived from the policy as:

$${U}_{dt} = \frac{{D}_{t}}{{E}_{t}} \qquad ( 3 )$$

where Dₜ is the number of data points delivered and Eₜ is the number of data points expected at t. It is worth noting that this policy 114 does not include a specification of the condition that should trigger a particular policy 114. The underlying retrieve-all-you can policy 114 mandates that the decision to trigger any other policy should be based upon the changing resource levels on a device 22-36, 128, 132 over time. Such decision are taken autonomously within the sensor network 20 and revoked as soon as the conditions favor towards improving the data utility to 1.

Referring to policy-based data flow optimization 122, the sensor network 20 selects and connects different components 100 together and forms a data flow graph such that both the data utility (see Equation (3)) and resource utility (see Equation (1)) matrices are kept as close as possible to 1, while the data requirements of the applications are met. A utility matrix with a value greater than 1 is an indication of suboptimal usage of resources and a utility less than 1 indicates missing data points for the applications. OData technique 140 avoids both undesired conditions. Given a set of components 100, resources available to a device 22-36, 128, 132, constraints 112 on the resources, restrictions 116 on the configurations and a set of policies 114, data flow with the sensor network 20 has been improved. The improvement is located at different places/parts of the sensor network 20. In one case, each device 22-36 (sensor nodes 22-36) hosts the optimization process 140 and makes policy decisions individually. Alternatively, the policies 114 may require several devices 22-36 to be considered (i.e. a spatial or temporal grouping policy). Here, the improvement/optimization process 140 is carried out centrally at a single coordinating server 78, or by clusterheads 22-36 hosting the optimization controller to carry out cluster-wide data flow optimizations. The rest of the description provides details of some optimization steps that OData technique 140 performs to determine an optimized dataflow.

Referring to pre-profiling and modeling, a prerequisite of OData's optimization 140 is the initialization of the state tier 124, 126 by establishing the footprints 124 of executable components 100 in the data tier 100, 112, 114, 116. For this purpose, the components 100 such as sensor data acquisition, data filters and telemetry are pre-profiled under controlled conditions to establish baseline footprints 124 on various resources such as power, network and memory usage. “C” is defined as a set of all the components 100 available on the device 22-36 and cₓ ⊂ C denotes the component 102 of interest for determining the footprint 124. Also, let G_{c}_{ₓ} be the set of all possible configurations that component cₓ 102 can have and “R” be the set of all the resources on the device 22-36. A footprint matrix F_{cx} is calculated as:

F(cₓ)=[f(r_{y}, g_{z})|r_{y} ⊂ R and g_{z} ⊂G_{c}_{ₓ}] (4)

Here, f(r_{y}, g_{z}) determines the impact of component cₓ on a resource in the resource set “R” when the component's configurations are varied within the set G_{c}_{ₓ}. Here, r_{y} refers to a particular resource under consideration in a given configuration g_{z}. The footprint matrix for one of the resources r_{y} is expressed as:

F(cₓ, r_{y})=[f(r_{y}, g_{z})|g_{z} ⊂ G_{c}_{ₓ}] (5)

The footprint matrix in equation (4) can be computed in many different ways. One way is to obtain or calculate the resource's decay/consumption curve. For instance, in case of battery, this could be the manufacturer's time/discharge curve assuming a fixed load. Using this curve and running experiments in the lab to determine the power consumption of cₓ, the footprint matrix can be calculated.

Referring to anomaly tracking 142, at run-time, a component 102-110 operates that is dedicated to the task of tracking anomalies 142 in the data and resource utility matrices defined in Equations (3) and (1). In the event of a fault (such as a battery running low on voltage/charge, network disconnections or sluggish connections etc.), the anomaly tracker dynamically updates the available resource matrix R based on the set of constraints K and calculates both the data and resource utility matrices Uᵣₜ and U_{dt}, building a new Constraint Optimization Problem matrix (COP) as follows:

COPₜ=[Uᵣₜ, U_{dt}R] (6)

This matrix defines the current data and utility levels in the context of available resources. Since this COP matrix is built on top of utility functions, it can be easily modified to detect an actual resource anomaly in a proactive manner. For example, if the absolute minimum data rate that can be tolerated by an application is x samples per minute, the corresponding utility functions can be manipulated to trigger an anomaly when the data rate approaches towards x.

Referring to cost estimation 120, when an anomaly has been detected, the next step is to estimate the total cost of the data flow model that is running. Some of the components shown FIG. 6 can be pre-profiled and their cost matrices determined in the modeling stage. For others, the cost matrices cannot be determined until runtime. For example, event detectors that take some input data, process it and produce some output. In this case, the cost of an edge eₜ at time t merging out of an event detection filter is entirely dependent upon the input data. Thus, as shown in FIG. 8, the number of data points e 147, 149 that a low threshold (TH) event detector 150 152 finds is different at time tₓ as compared to the data points f at time t_{y} as the detection performance varies with the actual data.

The objective of cost estimation step is to determine the total cost of the data flow graph such as in FIG. 6. However, since the resources and their cost matrices are different, it is non-trivial to combine the costs. For instance, the footprint on battery will be determined in the units of power consumed, whereas the footprint on the network bandwidth will be computed as bytes per second. Likewise, the CPU foot-print will be expressed as number of CPU cycles consumed by a particular data flow graph vertex.

FIG. 8 illustrates undetermined resource footprints 124 of some components 100, whilst FIG. 9 illustrates a data flow graph generated according to the Data Flow Optimization Process 140.

OData technique 140 provides a solution to this problem by choosing a target resource r_{y} and then suggesting a cost translation function Z(rₓ, r_{y}) to express the costs of a resource rₓ in terms of the target resource r_{y}. For instance, if power is a target resource to optimize against, the following will be the outcomes of a translation function for different resources:
1. Z(cpu; power)=power consumed by n number of CPU cycles executed;
2. Z(communication; power)=power consumed by transferring the n number of bytes; and
3. Z(storage; power)=power consumed by storing n number of bytes on the flash memory.

Likewise, if the optimization target resource is the network output, then the cost translation function will express every resource cost in terms of the number of bytes that end up being transmitted (at the application level). In this way, the cost of each vertex in the data flow graph is determined and the total cost calculated as the sum of cost factors of all the vertices.

Referring to utility maximization 146, the total cost along with the COP from Equation (6) is then used to determine the alternative data flow graph that should reduce the cost in such a way that both data utility and resource utility are improved towards value 1 (100%). First, a set of ranked policies 114 are considered that provide guidelines to alternative data flows. Examples of such policies 114 in the order of ranks are:
1. Rank x: Retrieve-all-you-can;
2. Rank x−1: Retrieve only x minute averages of sensor y. For the rest, retrieve-all-you-can; and
3. Rank x−2: Do not send data, store the data on local buffer.

If the current data flow graph follows a policy at rank x, the utility maximization 122 carries out the following steps:
1. Select the policy 114 at rank x−1;
2. Form a new graph with the components 100 needed to satisfy the new policy 114
3. Calculate the cost of the vertices of new data flow graph. This is used to calculate the projections on the resource consumption under the new data flow graph. For instance, for power resource, the total cost is expressed as the total power consumed by the data flow graph in a certain time interval. The lifetime of battery can be determined under the new data flow graph by simple linear extrapolation or applying the battery discharge curve function on the power consumption.
4. Determine the data and resource utility by analyzing the cost associated with the edges of the new data flow graph 144. This cost 144, which is the description of data points being produced, processed and transmitted tells how did closely does the graph satisfy the temporal and spatial resolution dimensions of data as prescribed in the policy (see Equation (2)). Thus, the utility matrices from Equations (3) and (1) are calculated.
5. If both the utilities are improved and the resource consumption projections meet the policy specifications, the new data flow graph is then executed. Otherwise, the next lowest ranked policy 114 is selected and the above-mentioned steps 1-4 above are repeated.

The new data flow graph to be executed may differ from the existing one, having a different combination of components 100, configurations and connectivity. As an example, consider the graph shown in FIG. 6 changed to the one shown in FIG. 9. In this case, the optimization process 140 decides to stop sensing data for Sensor z, stops using the communication component 100 for sending data (in order to save power) and, activates a new component 100 that archives data locally on a buffer 154 of the sensor node 22-36 for later retrieval purposes.

In the application, unless specified otherwise, the terms “comprising”, “comprise”, and grammatical variants thereof, intended to represent “open” or “inclusive” language such that they include recited elements but also permit inclusion of additional, non-explicitly recited elements. Some equations of the application may be expressed in a matrix or matrices form.

As used herein, the term “about” or “estimation”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

### REFERENCE NUMERALS

10 known sensor network
12 physical phenomena
14 applications
20 sensor network
22 sensor node
24 sensor node
26 sensor node
28 sensor node
30 sensor node
32 sensor node
34 sensor node
36 sensor node
40 cable connection
42 cable connection
44 cable connection
46 cable connection
48 cable connection
50 cable connection
52 cable connection
54 cable connection
56 repeater
60 wireless connection
62 wireless connection
64 wireless connection
66 wireless connection
70 TCP/IP link
72 remote base station
74 cellular modem
76 satellite modem
78 base station computer
80 radio transmitter
100 components
102 component
104 component
106 component
108 component
110 component
112 constraint
114 policy
116 restriction
118 anomaly tracking
120 cost estimation
122 optimization
124 components' footprints
126 resource status
128 sensor
130 processing filter
132 sensor
134 processing filter
136 sensor
138 telemetry
140 Data Flow Optimization Process
142 anomaly tracking
144 cost estimation
146 utility optimization
147 data points
148 policy execution
149 data points
150 low threshold (TH) event detector
152 low threshold (TH) event detector
154 buffer

1. Method of using a sensor network for improving data flow of the sensor network, the method comprising:
Identifying components of the sensor network;
Estimating resource footprints of the components; and
Modifying policies of the sensor network for governing data flow.

2. Method of claim 1 further comprising:
Checking constraints of the sensor network.

3. Method according to claim 1 further comprising:
Determining restrictions of the sensor network.

4. Method of claim 1 further comprising:
Examining resource status of the sensor network.

5. Method of claim 1, wherein
The modifying policies of the sensor network comprises choosing some of the components dynamically for improving resource consumption or data delivery.

6. Method of claim 1 further comprising:
Tracking anomaly of the sensor network for updating resource utility of the sensor network.

7. Method of claim 1 further comprising:
Calculating cost of the data flow for improving data output of the sensor network.

8. Method of claim 2, wherein
The Checking constraints of the sensor network comprises computing resource utility (Uᵣ) of at least one of the component according to the equation of
$${U}_{rt} = \frac{{S}_{t}}{{E}_{t}} ,$$
Sₜ being a number of data points served by a particular resource and Eₜ being a number of data points expected at time t.

9. Method of claim 1 further comprising
Formulating at least one of the policies according to the equation of pᵢ={d, t, r}, Pᵢ being one of the policies, d being a set of sensor data with both spatial context and temporal resolution, t being a time constraint on a sampling data of the sensor network and r being a ranked priority of the policy.

10. Method of claim 9 further comprising
Measuring data utility U_{d} of the at least one policy according to the equation of
$${U}_{dt} = \frac{{D}_{t}}{{E}_{t}} ,$$
Dₜ being the number of data points delivered, and Eₜ being the number of data points expected at time t.

11. Method of claim 1, wherein
The estimating resource footprints (F_{cx}) of the sensor network is performed according to the equation of F(cₓ)=[f(r_{y}, g_{z})|r_{y} ⊂ R and g_{z} ⊂ G_{c}_{ₓ}υ, Cₓ being one of the components, cₓ ⊂ C being a component of interest, C_{c}_{ₓ} being a set of all possible configurations the component cₓ, available, “R” be the resources on the sensor network, f(r_{y}, g_{z}) being the impact of component cₓ on a resource in the resource set R when the component's configurations are varied within the set G_{c}_{ₓ}.

12. Method of claim 1, wherein
The estimating resource footprints (F_{c1x, r1y}) of one of the components is performed according to the equation of F(cₓ, r_{y})=[f(r_{y}, g_{z})|g_{z} ⊂ G_{c}_{ₓ}], Cₓ being one of the components, cₓ ⊂ C being a component of interest, G_{c}_{ₓ} being a set of all possible configurations the component cₓ, available, “R” be the resources on the sensor network, f(r_{y}, g_{z}) being the impact of component cₓ on a resource in the resource set R when the component's configurations are varied within the set G_{c}_{ₓ}.

13. Method of claims 8, wherein
The tracking anomaly of the sensor network is performed according to the equation of COPₜ=[Uᵣₜ, U_{dt}, R], R being the resource available at time t, Uᵣₜ being the resource utility at time t and U_{dt} being the data utility at time t.

14. Method of claim 1, wherein
The modifying policies of the sensor network comprises
a. selecting one of the policies at rank x−1;
b. Forming a new graph with the components needed to satisfy the new policy;
c. Calculating the cost of vertices of the new data flow graph;
d. Deciding data and resource utility by analyzing the cost associated with the edges of the new data flow graph;
e. If both the data and resource utilities are improved and the resource consumption projections meet the policy specifications, executing the new data flow graph, if not, adopting a lower ranked policy and following the above-mentioned steps “a-d” again till both the data and resource utilities are improved and the resource consumption projections meet the policy specifications.

15. Sensor network comprising:
At least one sensor node for monitoring physical phenomena, and
A base station computer connected to the at least one sensor node for executing its installed applications based on data collected by the sensor node, wherein the sensor network is configured to
a. identify components of the sensor network;
b. estimate resource footprints of the components; and
c. modify policies of the sensor network for governing data flow.

16. Method of installing a Sensor network comprising:
Loading at least one computer program to the sensor network for
a. identify components of the sensor network;
b. estimate resource footprints of the components; and
modify policies of the sensor network for governing data flow.

17. Method of claim 10, wherein
The tracking anomaly of the sensor network is performed according to the equation of COPₜ=[Uᵣₜ, U_{dt}, R], R being the resource available at time t, Uᵣₜ being the resource utility at time t and U_{dt} being the data utility at time t.
